(19) United States
(12) Patent Application Publication
(10) Pub. No.: US 2016/0371222 A1
(43) Pub. Date: Dec. 22, 2016

(54) COHERENCY DRIVEN ENHANCEMENTS TO A PERIPHERAL COMPONENT INTERCONNECT (PCI) EXPRESS (PCIe) TRANSACTION LAYER

(71) Applicant: QUALCOMM Incorporated, San Diego, CA (US)

(72) Inventors: Shaul Yohai Yifrach, Haifa (IL); Amit Gil, Zichron Yaakov (IL); James Lionel Panian, San Marcos, CA (US); Ofer Rosenberg, Ramot Menashe (IL)

(21) Appl. No.: 15/184,181

(22) Filed: Jun. 16, 2016

Related U.S. Application Data
(60) Provisional application No. 62/182,815, filed on Jun. 22, 2015.

(51) Int. Cl. G06F 13/42; G06F 13/40; G06F 12/08

(52) U.S. Cl. CPC G06F 13/4282; G06F 12/0828; G06F 13/4022; G06F 2212/621; G06F 2213/0026

(57) ABSTRACT

Coherency driven enhancements to a PCIe transaction layer are disclosed. In an exemplary aspect, a coherency agent is added to a PCIe system to support a relaxed consistency model for use of memory therein. In particular, endpoints can request ownership of portions of the memory to read from and write to the memory. The coherency agent assigns an address range including the requested portions. The requesting endpoint copies the contents of the memory corresponding to the assigned address range into local endpoint memory to perform read and write operations locally. The owning endpoint may provide an updated snapshot of the copied memory contents upon request. At completion of use of the copied memory contents, or upon request from the coherency agent, ownership of the address range reverts back to the root complex, and the endpoint sends the updated contents back to the address range in the system memory element.

### PRIORITY CLAIM

The present application claims priority under 35 U.S.C. §119(e) to U.S. Provisional Patent Application Ser. No. 62/182,815 filed on Jun. 22, 2015 and entitled “COHERENCY DRIVEN ENHANCEMENTS TO A PERIPHERAL COMPONENT INTERCONNECT (PCI) EXPRESS (PCIe) TRANSACTION LAYER,” the contents of which is incorporated herein by reference in its entirety.

### BACKGROUND

### I. Field of the Disclosure

The technology of the disclosure relates generally to Peripheral Component Interconnect (PCI) express (PCIe) systems.

### II. Background

Mobile communication devices have become increasingly common in modern society. The increasing popularity of such mobile communication devices is driven, in part, by the increased functionality available on these devices. Such increased functionality is enabled by the inclusion of ever more complex integrated circuits (ICs) within the mobile communication devices. As the number and complexity of the ICs within the mobile communication devices has increased, so has the need for the various ICs to communicate with one another.

Several standards have been published outlining various protocols that allow ICs to communicate with one another. A popular protocol is the Peripheral Component Interconnect (PCI) protocol, which comes in various flavors, including the PCI express (PCIe) protocol. While useful as IC to IC communication protocols, the PCI and PCIe protocols may also be used to couple a mobile terminal to a remote device through a cable or other connector.

The PCIe protocol is frequently used to control access to memory elements. In many instances more than one PCIe component may want to access the memory elements concurrently. In such instances, such access requests are sent to a system memory (or device memory) to read/write data. However, PCIe is defined as not coherent. That is, modifications to the system memory (or the device memory) are not automatically communicated to other PCIe components. In short, it may be difficult to manage and control access to the memory elements correctly. Thus, there needs to be a better mechanism through which such concurrent use of memory resources is managed.

### SUMMARY OF THE DISCLOSURE

Aspects disclosed in the detailed description include coherency driven enhancements to a Peripheral Component Interconnect (PCI) express (PCIe) transaction layer. In an exemplary aspect, a coherency agent is added to a PCIe system to support a relaxed consistency model for use of memory in the PCIe system. The PCIe system may include a system memory element with data stored therein. Rather than require endpoints of the PCIe system to read from and write to the system memory element, exemplary aspects of the present disclosure allow the endpoints to request ownership of portions of the system memory element. Such portions may be defined by an address range of the system memory element. The coherency agent assigns a requested address range to a requesting endpoint. This assignment may sometimes be referred to as assigning ownership. The requesting endpoint copies contents of the system memory element corresponding to the assigned address range into local endpoint memory. The requesting endpoint then performs local read and write operations on the copied memory contents. The owning endpoint may send an updated snapshot of the copied memory contents (as updated by any local write operations) if requested by a root complex or other endpoint. At completion of use of the copied memory contents by the endpoint or after instruction from the coherency agent of the root complex, the ownership of the address range reverts back to the root complex, and the endpoint sends updated contents back to the address range in the system memory element.

In this regard, in one aspect, a method for controlling a host memory in a PCIe system is provided. The method includes receiving, at a root complex of a host associated with a host memory in the host, a request from a first endpoint for access to a first portion of data stored in the host memory. The method further includes requesting, to a coherency agent of the host, an ownership of an address range associated with the first portion of the data from the host. The method further includes assigning, by the coherency agent, the ownership of the address range from the host to the first endpoint and providing data associated with the address range to the first endpoint. The method further includes receiving, from the first endpoint, modified data associated with the address range when the ownership of the address range returns to the host.

In another aspect, a host system of a PCIe system is provided. The host system includes a PCIe bus interface configured to be coupled to at least a first endpoint and a second endpoint through a PCIe bus. The host system further includes a host memory comprising data stored therein, at least a first portion of the data and a second portion of the data associated with an address range. The host system further includes a root complex associated with the host memory, configured to receive a request for ownership of the first portion of the data associated with the address range from the first endpoint from the PCIe bus. The host system further includes a coherency agent configured to control ownership of the address range.

In another aspect, a method for managing data in an endpoint of a PCIe system is provided. The method includes requesting, by a first endpoint to a root complex associated with a host memory, access to a portion of data stored in the host memory. The method further includes receiving, from the root complex, data associated with an address range and ownership of the address range. The method further includes storing, at a local memory of the first endpoint, the data associated with the address range. The method further includes providing, to the root complex, modified data associated with the address range in response to the ownership of the address range returning to a host system.

In another aspect, an endpoint of a PCIe system is provided. The endpoint includes a local memory. The endpoint also includes processing circuitry coupled to the local memory. The processing circuitry of the endpoint is configured to request, to a root complex associated with a host memory of a PCIe system, access to a portion of data stored in the host memory. The processing circuitry of the endpoint is further configured to receive, from the root complex, data associated with an address range and ownership of the address range. The processing circuitry of the endpoint is further configured to store, at the local memory of the endpoint, the data associated with the address range. The processing circuitry of the endpoint is further configured to provide, to the root complex, modified data associated with the address range in response to the ownership of the address range returning to the PCIe system.

In another aspect, a host system of a PCIe system is provided. The host system includes a means for interfacing with at least a first endpoint and a second endpoint through a PCIe bus. The host system further includes a means for storing data, at least a first portion of the data and a second portion of the data associated with an address range. The host system further includes a means for processing data ownership requests for the data stored in the means for storing data, configured to receive a request for ownership of the first portion of the data associated with the address range from the first endpoint from the PCIe bus. The host system further includes a means for controlling memory configured to control ownership of the address range.

In another aspect, a PCIe system is provided. The PCIe system includes a host system, including a PCIe bus interface configured to be coupled to at least an endpoint of a PCIe system through a PCIe bus. The host system further includes a host memory including data stored therein, at least a portion of the data associated with an address range. The host system further includes a root complex associated with the host memory, configured to receive a request for ownership of the portion of the data associated with the address range from the endpoint from the PCIe bus. The host system further includes a coherency agent configured to control ownership of the address range.

The PCIe system further includes the endpoint, including a local memory and processing circuitry configured to request, to the root complex, access to the portion of the data stored in the host memory. The processing circuitry is further configured to receive, from the root complex, the data associated with the address range and the ownership of the address range. The processing circuitry is further configured to store, at the local memory, the data associated with the address range. The processing circuitry is further configured to provide, to the root complex, modified data associated with the address range in response to the ownership of the address range returning to the host system.

### BRIEF DESCRIPTION OF THE FIGURES

FIG. 1 is a block diagram of a conventional Peripheral Component Interconnect (PCI) express (PCIe) system;

FIG. 2 is a block diagram of an exemplary PCIe system including coherency driven enhancements to a PCIe transaction layer;

FIG. 3 is a simplified state diagram of memory elements in the PCIe system of FIG. 2;

FIG. 4 is an exemplary message signal chart for coherency signaling between elements of the PCIe system of FIG. 2;

FIG. 5 is a flowchart illustrating an exemplary method for controlling a host memory;

FIG. 6 is a flowchart illustrating an exemplary method for managing data in an exemplary PCIe endpoint; and

FIG. 7 is a block diagram of an exemplary processor-based system that can include the PCIe system of FIG. 2.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include coherency driven enhancements to a Peripheral Component Interconnect (PCI) express (PCIe) transaction layer. In an exemplary aspect, a coherency agent is added to a PCIe system to support a relaxed consistency model for use of memory in the PCIe system. The PCIe system may include a system memory element with data stored therein. Rather than require endpoints of the PCIe system to read from and write to the system memory element, exemplary aspects of the present disclosure allow the endpoints to request ownership of portions of the system memory element. Such portions may be defined by an address range of the system memory element. The coherency agent assigns a requested address range to a requesting endpoint. This assignment may sometimes be referred to as assigning ownership. The requesting endpoint copies contents of the system memory element corresponding to the assigned address range into local endpoint memory. The requesting endpoint then performs local read and write operations on the copied memory contents. The owning endpoint may send an updated snapshot of the copied memory contents (as updated by any local write operations) if requested by a root complex or other endpoint. At completion of use of the copied memory contents by the endpoint or after instruction from the coherency agent of the root complex, the ownership of the address range reverts back to the root complex, and the endpoint sends updated contents back to the address range in the system memory element.

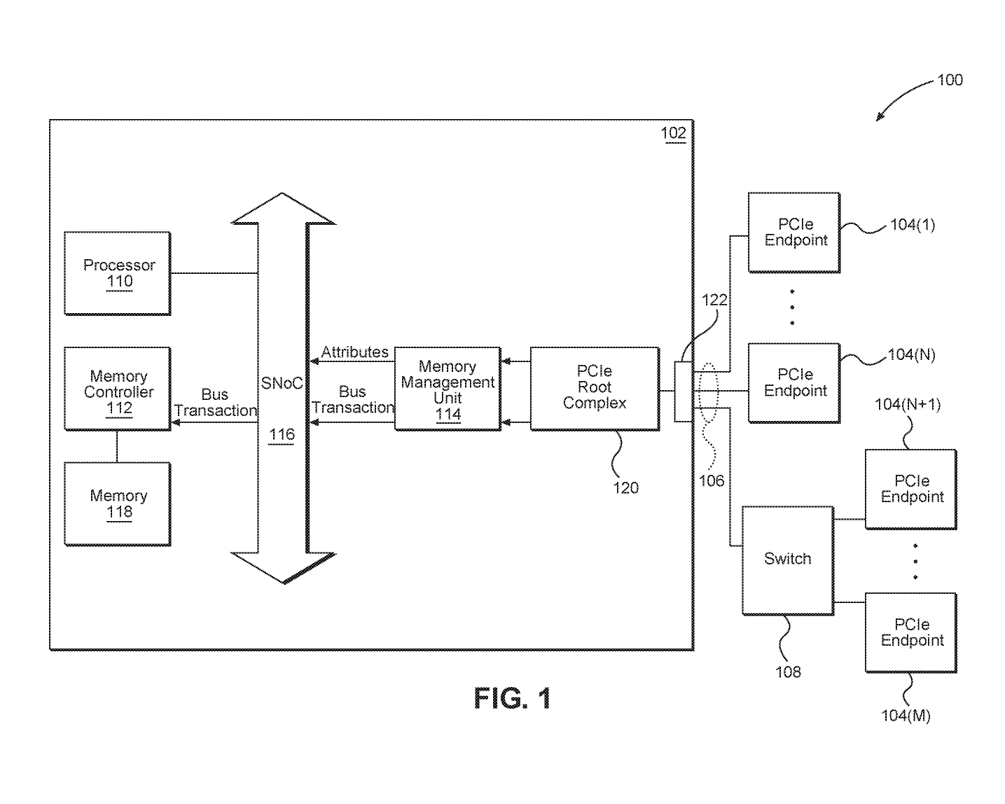

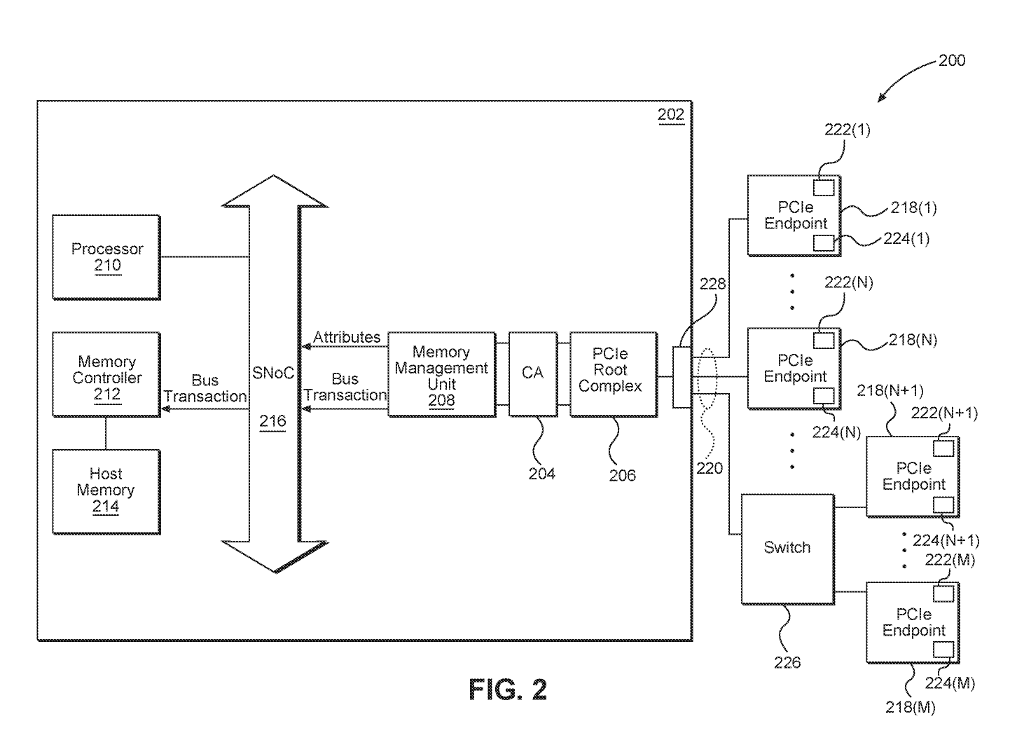

Before discussing exemplary aspects of coherency driven enhancements to a PCIe transaction layer, a brief overview of a conventional PCIe system is first provided in FIG. 1. The discussion of specific exemplary aspects of coherency driven enhancements to a PCIe transaction layer starts with reference to FIG. 2.

In this regard, FIG. 1 is a block diagram of a conventional PCIe system 100. The conventional PCIe system 100 includes a host system 102, which may be a central processing unit (CPU), a system on a chip (SoC), or the like. The host system 102 is coupled to a plurality of PCIe endpoints 104(1)-104(M) through a PCIe bus 106. In a non-limiting example, the conventional PCIe system 100 includes a PCIe switch 108 that controls PCIe endpoints 104(N+1)-104(M). In this example, the PCIe endpoints 104(N+1)-104(M) are configured to communicate with the host system 102 via the PCIe switch 108. It should be appreciated that the PCIe protocol calls for a point to point connection between a host, such as the host system 102, and endpoints, such as the plurality of PCIe endpoints 104(1)-104(M). Thus, each connection may be considered its own bus. However, for the sake of convenience, such plurality of connections is termed the PCIe bus 106 herein. Further, point to multi-point capability may be achieved through use of a hub or the PCIe switch 108. As illustrated, PCIe endpoints 104(1)-104(N) are connected by point to point connection within the PCIe bus 106 and the PCIe endpoints 104(N+1)-104(M) are coupled to the PCIe switch 108. It should be appreciated that the PCIe system 100 may include multiple switches (not illustrated) or no switches (also not illustrated) without departing from the scope of the present disclosure. Likewise, the number of endpoints coupled to any switch may vary without departing from the scope of the present disclosure. Each of the plurality of PCIe endpoints 104(1)-104(M) may also be considered a slave relative to the host system 102.

With continued reference to FIG. 1, the host system 102 includes at least one processor 110, a memory controller 112, and a memory management unit (MMU) 114. The processor 110, the memory controller 112, and the MMU 114 are coupled to an internal bus 116 (e.g., a system network on a chip (SNoC) bus). The memory controller 112 is configured to control a memory 118, such as a dynamic random access memory (DRAM) or a double data rate (DDR) DRAM, for example. The host system 102 also includes a PCIe root complex (RC) 120 communicatively coupled to the MMU 114. The PCIe RC 120 is configured to control the plurality of PCIe endpoints 104(1)-104(M) and the PCIe switch 108 via a bus interface 122, which allows signals to be transmitted onto or received from the PCIe bus 106. Communication between the PCIe RC 120, and the plurality of PCIe endpoints 104(1)-104(M) and the PCIe switch 108 is based on transaction layer packets (TLPs) (not shown). Each TLP includes address information enabling the PCIe RC 120 to route the TLP correctly to the plurality of PCIe endpoints 104(1)-104(M) and the PCIe switch 108. In this regard, the PCIe RC 120 is analogous to a router of an internet-protocol (IP) network, and the TLPs are analogous to IP packets communicated in the IP network.

According to the PCIe protocol, TLPs are used to communicate transactions, such as read and write, as well as certain types of events, between the PCIe RC 120, and the plurality of PCIe endpoints 104(1)-104(M) and the PCIe switch 108. The PCIe protocol defines four (4) types of transactions, including memory transactions, input/output (I/O) transactions, configuration transactions, and message transactions. The memory transactions include Read Request, Write Request, and AtomicOp request transactions. For the memory transactions, PCIe is defined as not coherent. That is, modifications to the memory 118, for example, are not automatically communicated to other PCIe components such as the plurality of PCIe endpoints 104(1)-104(M). Thus, it may be difficult to manage and control access to the memory 118 from PCIe components such as the plurality of PCIe endpoints 104(1)-104(M), for example.

In this regard, FIG. 2 is a schematic diagram of an exemplary PCIe system 200 including coherency driven enhancements to a PCIe transaction layer. In exemplary aspects, the PCIe system 200 includes an exemplary host system 202. The host system 202 includes a means for controlling memory, such as an exemplary coherency agent 204 (referenced in drawings as CA), to effectuate functionality described below. In particular, the coherency agent 204 is added between a means for processing data ownership requests for data, such as an exemplary PCIe RC 206, and a MMU 208 to provide a relaxed consistency model to the PCIe system 200.

The host system 202 includes several elements similar to those described above with respect to the conventional host system 102 illustrated in FIG. 1. In particular, the host system 202 includes the MMU 208, at least one processor 210, a memory controller 212, a means for storing data, such as a host memory 214, and an internal bus 216 (e.g., a system network on a chip (SNoC) bus). These elements are similar to the MMU 114, the at least one processor 110, the memory controller 112, the memory 118, and the internal bus 116 in the conventional host system 102 illustrated in FIG. 1 and will not be described in further detail herein. The PCIe system 200 further includes a plurality of exemplary PCIe endpoints 218(1)-218(M) coupled to the PCIe RC 206 through a PCIe bus 220. Each of the plurality of PCIe endpoints 218(1)-218(M) includes a respective local memory of local memories 222(1)-222(M) and a respective processing circuit of processing circuits 224(1)-224(M), coupled to the local memory of the local memories 222(1)-222(M), configured to perform the functionality described below. Furthermore, in a non-limiting example, the PCIe system 200 includes a PCIe switch 226 that controls PCIe endpoints 218(N+1)-218(M). Accordingly, in this example, the PCIe endpoints 218(N+1)-218(M) are configured to communicate with the host system 202 via the PCIe switch 226. Furthermore, the PCIe RC 206 is coupled to a means for interfacing with endpoints, such as a bus interface 228 to communicate with, and control, the plurality of PCIe endpoints 218(1)-218(M) and the PCIe switch 226.

In exemplary aspects of the present disclosure, the relaxed consistency model is implemented when an endpoint, such as one of the plurality of PCIe endpoints 218(1)-218(M) may desire to read from and write to a portion of the host memory 214. Absent exemplary aspects of the present disclosure, each time the endpoint wants to read from or write to the host memory 214, corresponding messages must cross the PCIe bus 220. Exemplary aspects of the present disclosure eliminate these messages, thus reducing message traffic on the PCIe bus 220 by using the coherency agent 204 to assign ownership of an address range in which the desired portion of the contents of the host memory 214 is stored to a requesting endpoint (for the sake of example, PCIe endpoint 218(1)). Such reduction in the message traffic on the PCIe bus 220 may reduce latency in general on the PCIe bus 220 since there is greater bandwidth available for other messages. Once the ownership is assigned in this fashion, the PCIe endpoint 218(1) copies data stored in the address range, and therefore the desired portion of the host memory 214, to a local memory 222(1). The PCIe endpoint 218(1) may access the desired portion of the data in the address range faster by accessing the local memory 222(1) rather than having to communicate through the PCIe bus 220 to access the desired portion of the host memory 214 in the address range. The PCIe endpoint 218(1) may then perform read and write operations on the copied data until either the PCIe endpoint 218(1) completes its need for the copied data or the PCIe RC 206 requests the ownership back from the PCIe endpoint 218(1).

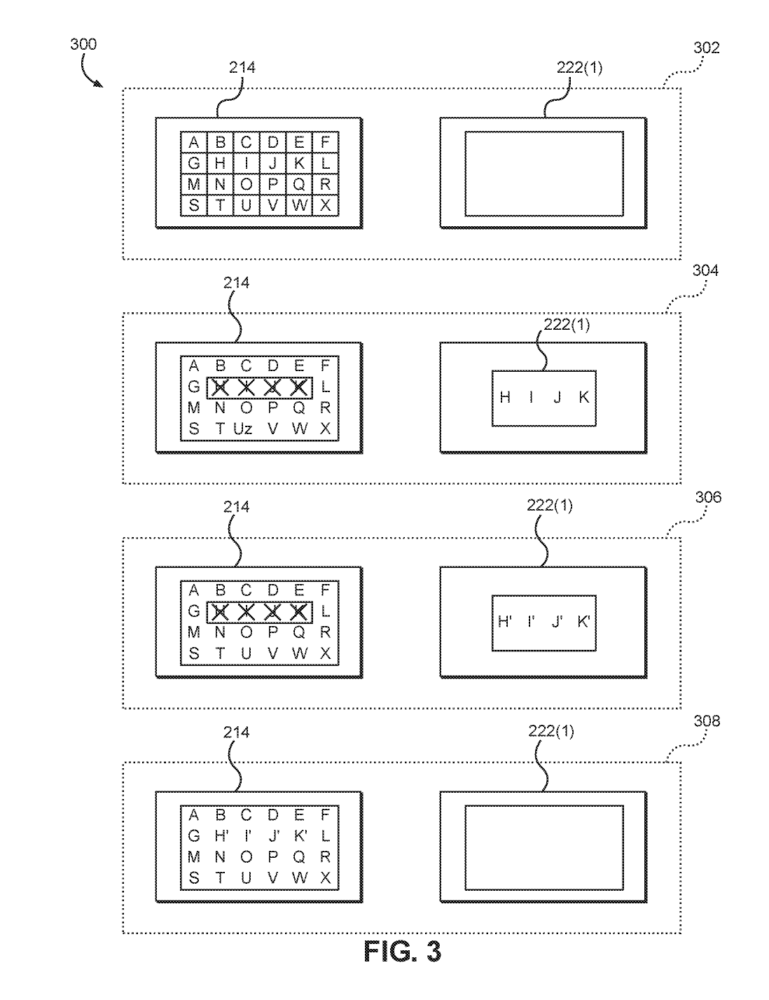

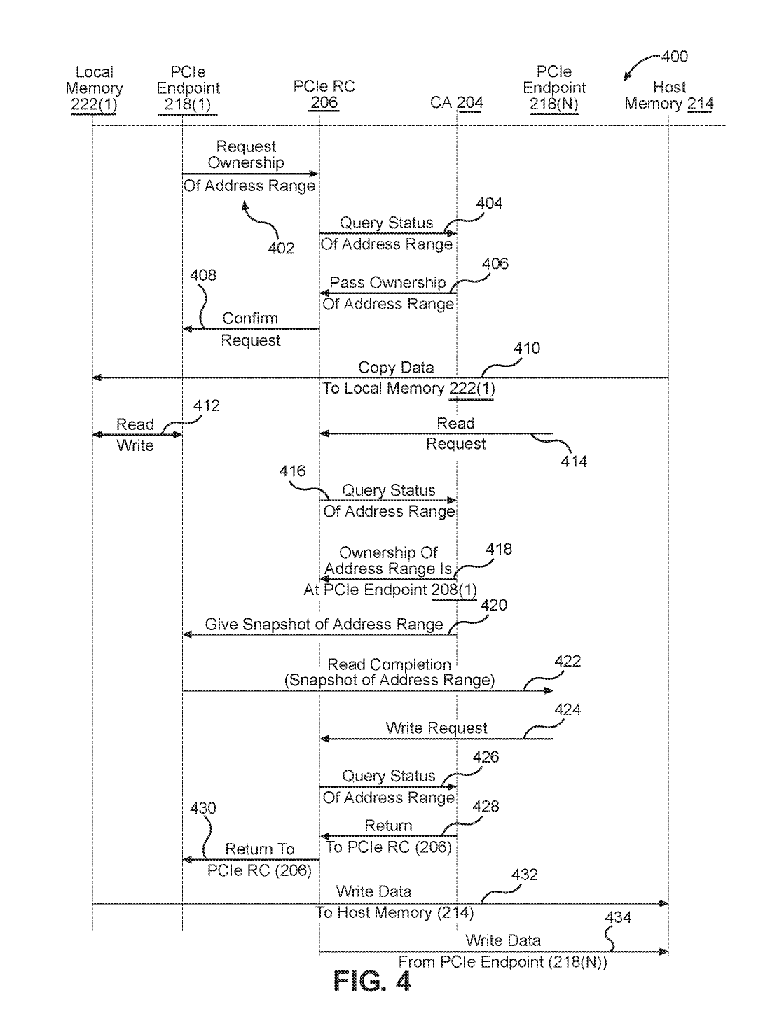

FIG. 3 is a simplified state diagram 300 of the host memory 214 and the local memory 222(1) of FIG. 2 as the signals are passed back and forth in message signal chart 400 of FIG. 4. Accordingly, both FIGS. 3 and 4 will be used in the following explanation. In this regard, in an initial state 302, the host memory 214 has data stored therein and the data may have associated addresses as is well understood. For the sake of example, an address range may refer to a block or portion of the data stored in the host memory 214. As illustrated, 214(A)-214(X) are the addresses of different blocks of data A-X. Likewise, the local memory 222(1) of the PCIe endpoint 218(1) may be empty in the initial state 302. The PCIe endpoint 218(1) may determine that the PCIe endpoint 218(1) needs to read from and write to a portion of the host memory 214. For the sake of example, the portion of the host memory 214 is the contents of the host memory 214 at address range 214(H)-214(K). However, it is noted that the portion of the host memory 214 may be less than the contents of the host memory 214 at the address range 214(H)-214(K). For example, the PCIe endpoint 218(1) may only desire access to the contents at address range 214(I)-214(J), but the coherency agent 204 may provide an address range of a predetermined size that is larger than the contents of the host memory 214 desired by the PCIe endpoint 218(1).

In this regard, the PCIe endpoint 218(1) may request ownership of the address range 214(H)-214(K) through signal 402 (FIG. 4). The PCIe RC 206 receives the signal 402 and queries of the status of the address range 214(H)-214(K) to the coherency agent 204 through signal 404. The coherency agent 204 determines that the address range 214(H)-214(K) is currently not assigned, and the coherency agent 204 then instructs the PCIe RC 206 to pass the ownership of the address range 214(H)-214(K) to the PCIe endpoint 218(1) through signal 406. The PCIe RC 206 confirms the request through signal 408 to the PCIe endpoint 218(1). The data H-K in the address range 214(H)-214(K) is then copied into the local memory 222(1) (signal 410).

With continued reference to FIG. 3, the data H-K is copied into the local memory 222(1) as shown in state 304. Likewise, the state 304 shows that the ownership of the address range 214(H)-214(K) has been assigned to some other entity and that reading from and writing to the address range 214(H)-214(K) in the host memory 214 is not allowed. The PCIe endpoint 218(1) then reads/writes the data H-K (signal 412) on the local memory 222(1), which may change the contents of the local memory 222(1) to data H′-K′ as illustrated by state 306. Note that the host memory 214 still has the data H-K stored therein.

With continued reference to FIG. 4, while the PCIe endpoint 218(1) has the ownership of the address range 214(H)-214(K), PCIe endpoint 218(N) sends a read request to the PCIe RC 206 through signal 414. The PCIe RC 206 responds with a query to the coherency agent 204 of the status of the address range 214(H)-214(K) through signal 416. The coherency agent 204 responds with an indication that the ownership of the address range 214(H)-214(K) is with the PCIe endpoint 218(1) through signal 418. The coherency agent 204 then requests that the PCIe endpoint 218(1) give a snapshot of the address range (i.e., snapshot of the data corresponding to the address range 214(H)-214(K)) through signal 420 (currently the data H′-K′ at the PCIe endpoint 218(1)). The PCIe endpoint 218(1) provides a read completion to the PCIe endpoint 218(N) through signal 422 to give the requested snapshot of the address range (i.e., the data H′-K′ corresponding to the address range 214(H)-214(K)) to the PCIe endpoint 218(N). Note that the snapshot of the address range may be sent through the host system 202 and not directly. However, if there is a direct PCIe connection between the PCIe endpoints 218(1) and 218(N), the snapshot of the address range may be provided directly.

At another time, the PCIe endpoint 218(N) may need to write to the address range 214(H)-214(K). A write request (signal 424) is sent to the PCIe RC 206. The PCIe RC 206 responds with a query to the coherency agent 204 of the status of the address range 214(H)-214(K) through signal 426. The coherency agent 204 responds by informing the PCIe RC 206 to return the ownership of the address range 214(H)-214(K) to the PCIe RC 206 (signal 428). The PCIe RC 206 then commands the PCIe endpoint 218(1) to return the ownership of the address range 214(H)-214(K) to the PCIe RC 206 (signal 430). The PCIe endpoint 218(1) then writes the data H′-K′ to the host memory 214 (signal 432) to update the host memory 214 with the changes made in the address range 214(H)-214(K) by the PCIe endpoint 218(1). Note that while the example assumes all data H-K is rewritten as H′-K′, the present disclosure is not so limited. For example, the PCIe endpoint 218(1) could return H′, I, J′, and K′, H, I′-K′, or any other combination of old and new values instead of H′-K′ depending on the changes actually made at the PCIe endpoint 218(1).

Thus, as illustrated in state 308 of FIG. 3, the address range 214(H)-214(K) now has the data H′-K′, which may be manipulated by the PCIe endpoint 218(N), either by assigning the ownership of the address range 214(H)-214(K) to the PCIe endpoint 218(N) as described above, or by allowing the PCIe RC 206 to retain the ownership of the address range 214(H)-214(K) and allow the PCIe endpoint 218(N) to read and write to the host memory 214. In this regard, the PCIe RC 206 writes the data provided in the write request (signal 424) by the PCIe endpoint 218(N) to the host memory 214 (signal 434).

It is also possible, although not illustrated, that the PCIe endpoint 218(1) returns the ownership of the address range 214(H)-214(K) when the PCIe endpoint 218(1) completes the task for which the ownership of the address range 214(H)-214(K) was transferred. In such an instance, the data H′-K′ may be copied back to the host memory 214 as previously described.

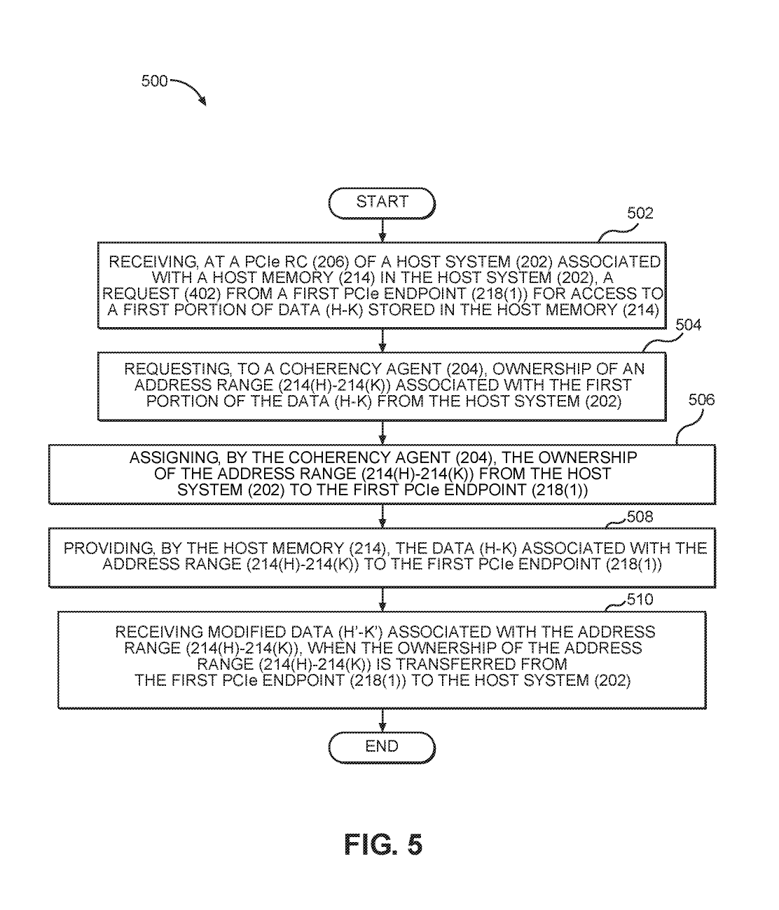

FIG. 5 is a flowchart 500 illustrating an exemplary method for controlling a host memory according to exemplary aspects. The method will be explained in conjunction with the exemplary PCIe system 200 of FIG. 2, the state diagram 300 of FIG. 3, and the message signal chart 400 of FIG. 4. The method includes receiving, at the PCIe RC 206 of the host system 202 associated with the host memory 214 in the host system 202, a request from a first PCIe endpoint 218(1) for access to a first portion of the data H-K stored in the host memory 214 (block 502). The PCIe RC 206 then requests, to the coherency agent 204 of the host system 202, the ownership of the address range 214(H)-214(K) associated with the first portion of the data H-K from the host system 202 (block 504). The coherency agent 204 then assigns the ownership of the address range 214(H)-214(K) from the host system 202 to the first PCIe endpoint 218(1) (block 506). The host memory 214 then provides the data H-K associated with the address range 214(H)-214(K) to the first PCIe endpoint 218(1) (block 508). Once the first PCIe endpoint 218(1) performs the desired operations on the data H-K, the next step is for the host system 202 to receive the modified data H′-K′ associated with the address range 214(H)-214(K), when the ownership of the address range is transferred from the first PCIe endpoint 218(1) to the host system 202 (block 510).

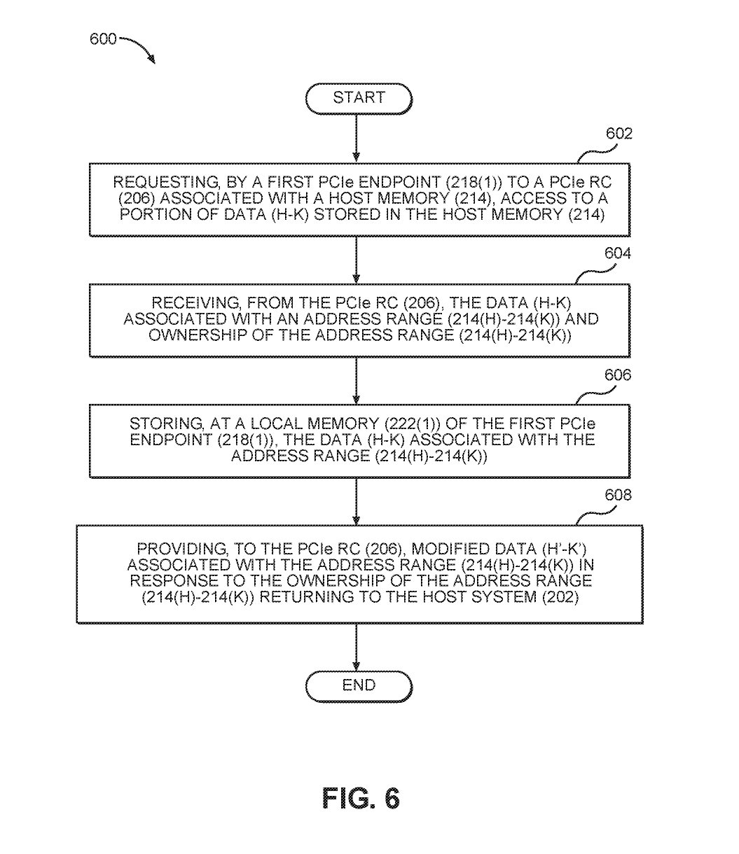

FIG. 6 is a flowchart 600 illustrating an exemplary method for managing data in an exemplary PCIe endpoint, such as the PCIe endpoint 218(1). The method includes requesting, by a first PCIe endpoint 218(1) to the PCIe RC 206 associated with the host memory 214, access to a portion of the data H-K stored in the host memory 214 (block 602). The method further includes receiving, from the PCIe RC 206, the data H-K associated with the address range 214(H)-214(K) and the ownership of the address range 214(H)-214(K) (block 604). Once the first PCIe endpoint 218(1) receives the data H-K and the ownership over the corresponding address range 214(H)-214(K), the first PCIe endpoint 218(1) stores, at the local memory 222(1), the data H-K associated with the address range 214(H)-214(K) (block 606). The method further includes providing, to the PCIe RC 206, the modified data H′-K′ associated with the address range 214(H)-214(K) in response to the ownership of the address range 214(H)-214(K) returning to the host system 202 (block 608).

The coherency driven enhancements to a PCIe transaction layer according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a smart phone, a tablet, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, an automobile, and a portable digital video player.

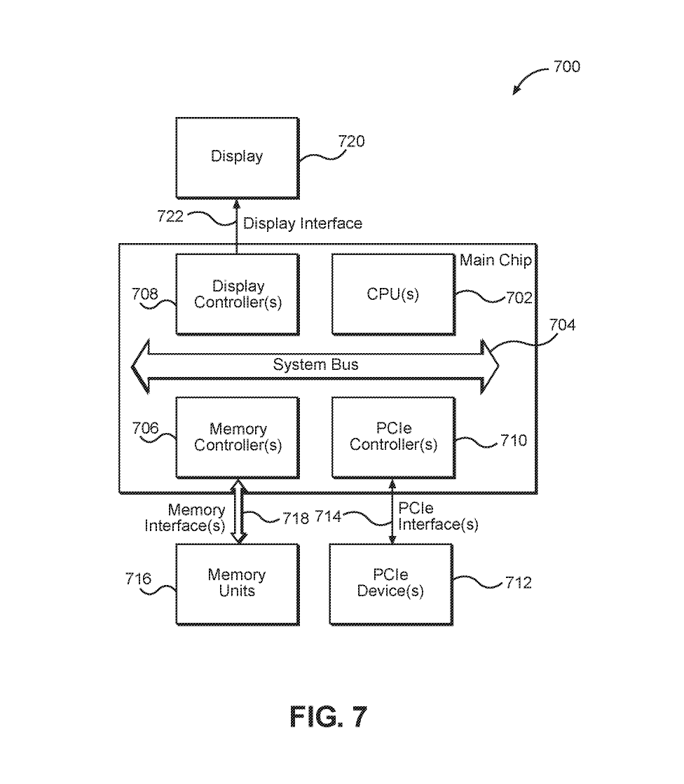

In this regard, FIG. 7 illustrates an example of a processor-based system 700 that can employ the PCIe system 200 illustrated in FIG. 2. In this example, the processor-based system 700 includes one or more central processing units (CPUs) 702, each including one or more processors (not illustrated). The CPU(s) 702 may have cache memory (not illustrated) coupled to the processor(s) (not illustrated) for rapid access to temporarily stored data. The CPU(s) 702 is coupled to a system bus 704. As is well known, the CPU(s) 702 communicates with these other devices by exchanging address, control, and data information over the system bus 704. For example, the CPU(s) 702 can communicate bus transaction requests to one or more memory controllers 706.

Other devices can be connected to the system bus 704. As illustrated in FIG. 7, these devices can include one or more display controllers 708 and one or more PCIe controllers 710, as examples. The PCIe controller(s) 710 may communicate with one or more PCIe devices 712, such as the plurality of PCIe endpoints 218(1)-218(M) of FIG. 2, through one or more PCIe interfaces 714 or the PCIe bus 220 illustrated in FIG. 2. The memory controller(s) 706 may interoperate with memory units 716 through one or more memory interfaces 718. Note that in an exemplary aspect, the memory interface(s) 718 may be a PCIe bus, like the PCIe bus 220 of FIG. 2. The display controller(s) 708 may communicate with a display 720 through a display interface 722. The display 720 can include any type of display, including, but not limited to, a cathode ray tube (CRT), a liquid crystal display (LCD), a plasma display, a light emitting diode (LED) display, etc.

While not illustrated in FIG. 7, the processor-based system 700 may also include a network interface device, which can be any device configured to allow exchange of data to and from a network (not illustrated). The network can be any type of network, including but not limited to a wired or wireless network, a private or public network, a local area network (LAN), a wireless local area network (WLAN), a wide area network (WAN), a BLUETOOTHTM network, and the Internet. The network interface device can be configured to support any type of communications protocol desired.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for controlling a host memory in a Peripheral Component Interconnect (PCI) express (PCIe) system, comprising:
receiving, at a root complex of a host associated with a host memory in the host, a request from a first endpoint for access to a first portion of data stored in the host memory;
requesting, to a coherency agent of the host, an ownership of an address range associated with the first portion of the data from the host;
assigning, by the coherency agent, the ownership of the address range from the host to the first endpoint;
providing data associated with the address range to the first endpoint; and
receiving, from the first endpoint, modified data associated with the address range when the ownership of the address range returns to the host.

2. The method of claim 1, further comprising storing, in the host memory, the modified data associated with the address range.

3. The method of claim 1, further comprising requesting, to the first endpoint, returning the ownership of the address range to the host, prior to receiving, from the first endpoint, the modified data associated with the address range.

4. The method of claim 1, further comprising receiving, at the root complex, the ownership of the address range from the first endpoint and returning the ownership of the address range to the host after receiving, from the first endpoint, the modified data associated with the address range.

5. The method of claim 1, further comprising:
receiving, at the root complex, a request from a second endpoint to read a second portion of the data stored in the host memory, the second portion of the data associated with the address range;
requesting, to the first endpoint, a snapshot of the data associated with the address range; and
providing, to the second endpoint, the snapshot of the data associated with the address range.

6. The method of claim 1, further comprising:
receiving, at the root complex, a request from a second endpoint for access to a second portion of the data stored in the host memory, the second portion of the data associated with the address range;
requesting, to the coherency agent, the ownership of the address range from the first endpoint;
requesting, to the first endpoint, returning the ownership of the address range to the host;
assigning, by the coherency agent, the ownership of the address range from the first endpoint to the second endpoint, after receiving, from the first endpoint, the modified data associated with the address range; and
providing, to the second endpoint, the data associated with the address range.

7. A host system of a Peripheral Component Interconnect (PCI) express (PCIe) system, comprising:
a PCIe bus interface configured to be coupled to at least a first endpoint and a second endpoint through a PCIe bus;
host memory comprising data stored therein, at least a first portion of the data and a second portion of the data associated with an address range;
a root complex associated with the host memory, configured to receive a request for ownership of the first portion of the data associated with the address range from the first endpoint from the PCIe bus; and
a coherency agent configured to control ownership of the address range.

8. The host system of claim 7, wherein the root complex is further configured to:
request, to the coherency agent, the ownership of the address range associated with the first portion of the data from the host system;
provide the data associated with the address range to the first endpoint;
the coherency agent further configured to assign the ownership of the address range from the host system to the first endpoint; and
store, in the host memory, modified data associated with the address range.

9. The host system of claim 8, wherein the root complex is further configured to:
provide the data associated with the address range to the first endpoint; and
receive, from the first endpoint, the modified data associated with the address range when the ownership of the address range returns to the host system.

10. The host system of claim 9, wherein the root complex is further configured to store, in the host memory, the modified data associated with the address range.

11. The host system of claim 9, wherein the root complex is further configured to request, to the first endpoint, returning the ownership of the address range to the host system, prior to receiving, from the first endpoint, the modified data associated with the address range.

12. The host system of claim 9, wherein the root complex is further configured to receive, from the first endpoint, the ownership of the address range and return the ownership of the address range to the host system after receiving, from the first endpoint, the modified data associated with the address range.

13. The host system of claim 9, wherein the root complex is further configured to:
receive, from the second endpoint, a request to read the second portion of the data stored in the host memory;
request, to the first endpoint, a snapshot of the data associated with the address range; and
provide, to the second endpoint, the snapshot of the data associated with the address range.

14. The host system of claim 9, wherein the root complex is further configured to:
receive, from the second endpoint, a request for access to the second portion of the data stored in the host memory;
request, to the coherency agent, the ownership of the address range from the first endpoint;
request, to the first endpoint, returning the ownership of the address range to the host system; and
provide, to the second endpoint, the data associated with the address range;
the coherency agent further configured to assign the ownership of the address range from the first endpoint to the second endpoint, after receiving, from the first endpoint, the modified data associated with the address range.

15. The host system of claim 7 integrated into an integrated circuit (IC).

16. The host system of claim 7 integrated into a device selected from the group consisting of: a set top box; an entertainment unit; a navigation device; a communications device; a fixed location data unit; a mobile location data unit; a mobile phone; a cellular phone; a smart phone; a tablet; a phablet; a server; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; and an automobile.

17. A method for managing data in an endpoint of a Peripheral Component Interconnect (PCI) express (PCIe) system, comprising:
requesting, by a first endpoint to a root complex associated with a host memory, access to a portion of data stored in the host memory;
receiving, from the root complex, data associated with an address range and ownership of the address range;
storing, at a local memory of the first endpoint, the data associated with the address range; and
providing, to the root complex, modified data associated with the address range in response to the ownership of the address range returning to a host system.

18. The method of claim 17, further comprising providing the modified data associated with the address range in response to receiving, from the root complex, a request to return the ownership of the address range to the host system.

19. The method of claim 17, further comprising returning, by the first endpoint, the ownership of the address range to the host system after providing, to the root complex, the modified data associated with the address range.

20. The method of claim 17, further comprising:
receiving, at the first endpoint, a request from the root complex from a second endpoint for a snapshot of the data associated with the address range; and
providing, to the second endpoint, the snapshot of the data associated with the address range.

21. The method of claim 17, further comprising:
receiving, at the first endpoint, a request to return the ownership of the address range to the host system;
providing, to the root complex, the data associated with the address range; and
returning, by the first endpoint, the ownership of the address range to the host system.

22. An endpoint of a Peripheral Component Interconnect (PCI) express (PCIe) system, comprising:
a local memory; and
processing circuitry, coupled to the local memory, and configured to:
request, to a root complex associated with a host memory of a PCIe system, access to a portion of data stored in the host memory;
receive, from the root complex, data associated with an address range and ownership of the address range;
store, at the local memory of the endpoint, the data associated with the address range; and
provide, to the root complex, modified data associated with the address range in response to the ownership of the address range returning to the PCIe system.

23. The endpoint of claim 22, wherein the processing circuitry is further configured to provide the modified data associated with the address range in response to receiving, from the root complex, a request to return the ownership of the address range to the PCIe system.

24. The endpoint of claim 22, wherein the processing circuitry is further configured to return the ownership of the address range to the PCIe system after providing, to the root complex, the modified data associated with the address range.

25. The endpoint of claim 22, wherein the processing circuitry is further configured to:
provide, to a second endpoint, a snapshot of the data associated with the address range in response to receiving from the root complex a request from the second endpoint for the snapshot of the data associated with the address range.

26. The endpoint of claim 22, wherein the processing circuitry is further configured to:
provide, to the root complex, the data associated with the address range and return, to the PCIe system, the ownership of the address range in response to receiving a request to return the ownership of the address range to the PCIe system.

27. A host system of a Peripheral Component Interconnect (PCI) express (PCIe) system, comprising:
a means for interfacing with at least a first endpoint and a second endpoint through a PCIe bus;
a means for storing data, at least a first portion of the data and a second portion of the data associated with an address range;
a means for processing data ownership requests for the data stored in the means for storing data, configured to receive a request for ownership of the first portion of the data associated with the address range from the first endpoint from the PCIe bus; and
a means for controlling memory, configured to control ownership of the address range.

28. The host system of claim 27, wherein the means for processing data ownership requests is further configured to:
request, to the means for controlling memory, the ownership of the address range associated with the first portion of the data from the host system;
provide the data associated with the address range to the first endpoint;
the means for controlling memory, further configured to assign the ownership of the address range from the host system to the first endpoint; and
store, in the means for storing data, modified data associated with the address range.

29. A Peripheral Component Interconnect (PCI) express (PCIe) system, comprising:
a host system comprising:
a PCIe bus interface configured to be coupled to at least an endpoint of a PCIe system through a PCIe bus;
host memory comprising data stored therein, at least a portion of the data associated with an address range;
a root complex associated with the host memory, configured to receive a request for ownership of the portion of the data associated with the address range from the endpoint from the PCIe bus; and
a coherency agent configured to control ownership of the address range; and
the endpoint comprising a local memory and processing circuitry configured to:
request, to the root complex, access to the portion of the data stored in the host memory;
receive, from the root complex, the data associated with the address range and the ownership of the address range;
store, at the local memory, the data associated with the address range; and
provide, to the root complex, modified data associated with the address range in response to the ownership of the address range returning to the host system.
